(19) United States
(12) Patent Application Publication
(10) Pub. No.: US 2024/0400011 A1
(43) Pub. Date: Dec. 5, 2024

(54) CONTROL DEVICE AND REMOTE CONTROL METHOD

(71) Applicant: TOYOTA JIDOSHA KABUSHIKI KAISHA, Toyota-shi (JP)

(72) Inventors: Go INOUE, Gotemba-shi (JP); Noritsugu IWAZAKI, Sunto-gun (JP); Takeshi KANOU, Seto-shi (JP); Yuki OKAMOTO, Naka-gun (JP); Yoshinori WATANABE, Isehara-shi (JP); Daiki YOKOYAMA, Miyoshi-shi (JP); Kento IWAHORI, Nagoya-shi (JP)

(73) Assignee: TOYOTA JIDOSHA KABUSHIKI KAISHA, Toyota-shi (JP)

(21) Appl. No.: 18/665,779

(22) Filed: May 16, 2024

(30) Foreign Application Priority Data
May 31, 2023 (JP) 2023-089978
Dec. 21, 2023 (JP) 2023-215438

(51) Int. Cl. B60T 7/12

(52) U.S. Cl. CPC B60T 7/12

(57) ABSTRACT

A control device configured to remotely control mobile objects includes: a generation section configured to generate a control command corresponding to each mobile object; a transmission section configured to transmit, to each mobile object, the control command corresponding to the mobile object; an information acquisition section configured to acquire command information related to the control command, internal sensor information related to a state of movement of the mobile object detected by an internal sensor mounted in the mobile object, and external sensor information related to a state of movement of the mobile object detected by an external sensor located outside the mobile object; and a detection section configured to detect that the control command is transmitted from the transmission section to one of the mobile objects not corresponding to the control command, by comparing at least two of the command information, the internal sensor information, and the external sensor information.

### CROSS-REFERENCE TO RELATED APPLICATION

This application claims priority to Japanese Patent Application No. 2023-089978 filed on May 31, 2023 and Japanese Patent Application No. 2023-215438 filed on Dec. 21, 2023, each incorporated herein by reference in its entirety.

### BACKGROUND

### 1. Technical Field

The present disclosure relates to a control device and a remote control method.

### 2. Description of Related Art

There has been known a technology for checking whether or not a vehicle is appropriately remotely controlled, by transmitting a command to move, by remote control, a wiper or the like of the vehicle and observing whether or not the wiper or the like of the vehicle moves in response to the command (for example, U.S. Pat. No. 10,532,771).

### SUMMARY

In the technology described above, when the vehicle that is being remotely controlled and a vehicle that is not being remotely controlled accidentally perform the same action at around the same time, or when it is not easy to observe an action of the vehicle, it is difficult to determine whether or not the vehicle is appropriately remotely controlled.

The present disclosure can be implemented in embodiments as follows.

A first embodiment of the present disclosure provides a control device configured to remotely control a plurality of mobile objects. The control device includes: a generation section configured to generate a control command corresponding to each of the plurality of mobile objects; a transmission section configured to transmit, to each of the plurality of mobile objects, the control command corresponding to the mobile object; an information acquisition section configured to acquire command information, internal sensor information, and external sensor information, the command information being related to the control command, the internal sensor information being related to a state of movement of the mobile object detected by an internal sensor mounted in the mobile object, the external sensor information being related to a state of movement of the mobile object detected by an external sensor located outside of the mobile object; and a detection section configured to detect that the control command is transmitted from the transmission section to one of the mobile objects not corresponding to the control command, by comparing at least two of the command information, the internal sensor information, and the external sensor information.

According to the control device in the embodiment, since at least two information of the command information, the internal sensor information, and the external sensor information do not coincide when the mobile object is not appropriately remotely controlled, it can be determined whether or not the mobile object is appropriately remotely controlled, based on whether or not the at least two information coincide.

In the control device in the embodiment, the detection section may be configured to detect that the control command is transmitted from the transmission section to one of the mobile objects not corresponding to the control command, by comparing at least two of a parameter value identified from the command information, a parameter value identified from the internal sensor information, and a parameter value identified from the external sensor information.

According to the control device in the embodiment, by comparing the parameter values, it can be detected that the control command is transmitted from the transmission section to one of the mobile objects not corresponding to the control command.

In the control device in the embodiment, the detection section may be configured to detect that the control command is transmitted from the transmission section to one of the mobile objects not corresponding to the control command, by comparing at least two of identification information that identifies the mobile object and that is identified from the command information, identification information that identifies the mobile object and that is identified from the internal sensor information, and identification information that identifies the mobile object and that is identified from the external sensor information.

According to the control device in the embodiment, by comparing these identification information, it can be detected that the control command is transmitted from the transmission section to one of the mobile objects not corresponding to the control command.

In the control device in the embodiment, the detection section may be configured to compare the command information and the external sensor information when the current situation matches a situation predetermined as a situation in which it is inappropriate to use the internal sensor information for the comparison.

According to the control device in the embodiment, it can be restrained from being erroneously determined that the mobile object is not appropriately remotely controlled, despite the fact that the mobile object is appropriately remotely controlled.

In the control device in the embodiment, the detection section may be configured to compare the command information and the internal sensor information when the current situation matches a situation predetermined as a situation in which it is inappropriate to use the external sensor information for the comparison.

According to the control device in the embodiment, it can be restrained from being erroneously determined that the mobile object is not appropriately remotely controlled, despite the fact that the mobile object is appropriately remotely controlled.

In the control device in the embodiment, the detection section may be configured to compare three pieces of information that are the command information, the internal sensor information, and the external sensor information.

According to the control device in the embodiment, it can be restrained from being erroneously determined that the mobile object is appropriately remotely controlled, despite the fact that the mobile object is not appropriately remotely controlled.

In the control device in the embodiment, the generation section may be configured to, when the detection section detects that the control command is transmitted from the transmission section to one of the mobile objects not corresponding to the control command, stop the mobile object moving by transmitting a control command to brake the mobile object.

According to the control device in the embodiment, movement of the unintended mobile object can be restrained from being continued.

A second embodiment of the present disclosure provides a remote control method for remotely controlling a plurality of mobile objects. The remote control method includes: generating a control command corresponding to each of the plurality of mobile objects; transmitting, to each of the plurality of mobile objects, the control command corresponding to the mobile object; acquiring command information, internal sensor information, and external sensor information, the command information being related to the control command, the internal sensor information being related to a state of movement of the mobile object detected by an internal sensor mounted in the mobile object, the external sensor information being related to a state of movement of the mobile object detected by an external sensor located outside of the mobile object; and detecting that the control command is transmitted to one of the mobile objects not corresponding to the control command, by comparing at least two of the command information, the internal sensor information, and the external sensor information.

According to the remote control method in the embodiment, since at least two information of the command information, the internal sensor information, and the external sensor information do not coincide when the mobile object is not appropriately remotely controlled, it can be determined whether or not the mobile object is appropriately remotely controlled, based on whether or not the at least two information coincide.

The present disclosure can also be implemented in various embodiments other than the control device and the remote control method. For example, the present disclosure can be implemented in embodiments as a remote control system, a mobile object, a method of manufacturing the mobile object, a vehicle, a method of manufacturing the vehicle, a computer program, a recording medium storing the computer program, and the like.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an explanatory diagram showing a configuration of a remote control system in a first embodiment;

FIG. 2 is an explanatory diagram showing a configuration of a vehicle in the first embodiment;

FIG. 3 is an explanatory diagram showing how vehicles move by remote control in a factory;

FIG. 4 is a flowchart showing details of a checking process in the first embodiment;

FIG. 5 is a flowchart showing details of a transmission process in the first embodiment;

FIG. 6 is an explanatory diagram showing how a remote control device performs transmission and reception of information; and

FIG. 7 is an explanatory diagram showing comparisons of command information, internal sensor information, and external sensor information.

### DETAILED DESCRIPTION OF EMBODIMENTS

### A. First Embodiment

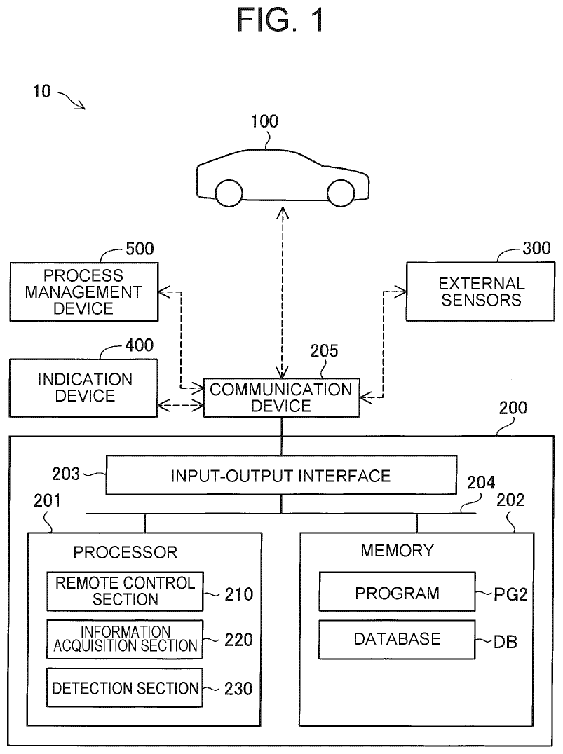

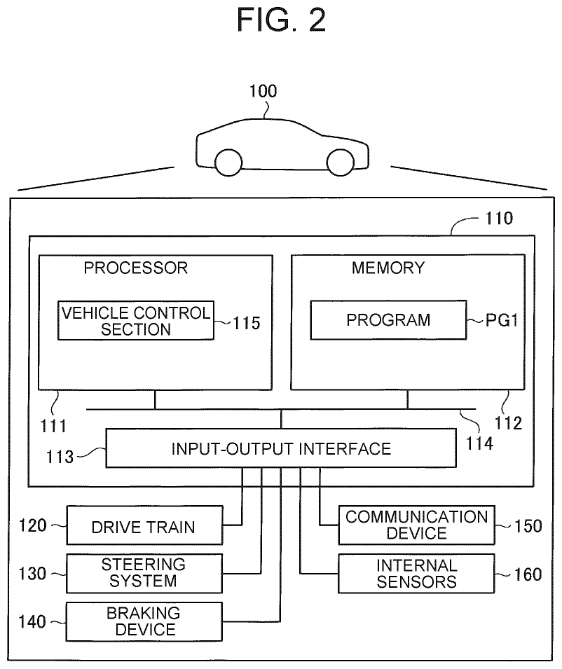

FIG. 1 is an explanatory diagram showing a configuration of a remote control system 10 in a first embodiment. FIG. 2 is an explanatory diagram showing a configuration of a vehicle 100 in the first embodiment. The remote control system 10 is used to cause a mobile object to move by remote control in a factory where the mobile object is manufactured. In the present embodiment, the mobile object is the vehicle 100. More specifically, the mobile object is a battery electric vehicle (BEV). Note that the mobile object is not limited to the battery electric vehicle and may be, for example, a gasoline vehicle, a hybrid electric vehicle, or a fuel cell electric vehicle. The mobile object is not limited to the vehicle 100 and may be, for example, an electric vertical takeoff and landing aircraft (so-called flying car).

As shown in FIG. 1, in the present embodiment, the remote control system 10 includes a plurality of the vehicles 100 that is remotely controllable, a remote control device 200 for remotely controlling each vehicle 100, external sensors 300 installed in the factory, an indication device 400 for indicating that an abnormality occurs in the factory, and a process management device 500 for managing the process of manufacturing each vehicle 100 in the factory. Note that the remote control device 200 is simply referred to as the control device in some cases. Although only one vehicle 100 is depicted in FIG. 1, the remote control device 200 remotely controls the plurality of vehicles 100.

As shown in FIG. 2, each vehicle 100 includes a vehicle control device 110 for controlling each part of the vehicle 100, a drive train 120 for accelerating the vehicle 100, a steering system 130 for changing a traveling direction of the vehicle 100, a braking device 140 for decelerating the vehicle 100, a communication device 150 for communicating with the remote control device 200 through wireless communication, and internal sensors 160. In the present embodiment, the drive train 120 includes a battery, a motor that is driven by electricity from the battery, and drive wheels that are rotated by the motor. The internal sensors 160 include at least one internal sensor. An internal sensor is a sensor mounted in the vehicle 100. An internal sensor is used to detect a physical amount related to a state of movement of the vehicle 100. An internal sensor may be used to detect identification information on the vehicle 100. Examples of the physical amount related to the state of movement of the vehicle 100 can include the position, speed, acceleration, azimuth angle, yaw-axis angular velocity (yaw rate), and yaw-axis angular acceleration of the vehicle 100. In the present embodiment, the internal sensors 160 may include a vehicle speed sensor for measuring the speed of the vehicle 100 and a yaw rate sensor for measuring the yaw-axis angular velocity of the vehicle 100.

The vehicle control device 110 is configured by using a computer including a processor 111, a memory 112, an input-output interface 113, and an internal bus 114. The processor 111, the memory 112, and the input-output interface 113 are connected through the internal bus 114 in such a manner as to be able to perform bi-directional communication. The drive train 120, the steering system 130, the braking device 140, the communication device 150, and the internal sensors 160 are connected to the input-output interface 113. A computer program PG1 is stored in the memory 112.

The processor 111 functions as a vehicle control section 115 by executing the computer program PG1. The vehicle control section 115 controls the drive train 120, the steering system 130, and the braking device 140. When a driver is on board the vehicle 100, the vehicle control section 115 can cause the vehicle 100 to travel by controlling the drive train 120, the steering system 130, and the braking device 140 according to operations by the driver. Regardless of whether or not a driver is on board the vehicle 100, the vehicle control section 115 can cause the vehicle 100 to travel by controlling the drive train 120, the steering system 130, and the braking device 140 according to a control command supplied from the remote control device 200. The vehicle control section 115 measures physical amounts representing a state of movement of the vehicle 100, by using the internal sensors 160.

As shown in FIG. 1, the remote control device 200 is configured by using a computer including a processor 201, a memory 202, an input-output interface 203, and an internal bus 204. The processor 201, the memory 202, and the input-output interface 203 are connected through the internal bus 204 in such a manner as to be able to perform bi-directional communication. A communication device 205 for communicating with the vehicles 100 through wireless communication is connected to the input-output interface 203. In the present embodiment, the communication device 205 can communicate with the external sensors 300, the indication device 400, and the process management device 500 through wired communication or wireless communication. A computer program PG2 and a database DB are stored in the memory 202. Note that the input-output interface 203, or a combination of the input-output interface 203 and the communication device 205, is referred to as a transmission section in some cases.

The processor 201 functions as a remote control section 210, an information acquisition section 220, and a detection section 230 by executing the computer program PG2. The remote control section 210 causes a vehicle 100 to travel by transmitting, to the vehicle 100, a control command to remotely control the state of movement of the vehicle 100. In the present embodiment, the remote control section 210 remotely controls the plurality of vehicles 100. Specifically, the remote control section 210 generates a control command for remotely controlling each of the plurality of vehicles 100. The remote control section 210 transmits the respective control commands corresponding to the plurality of vehicles 100 to the plurality of vehicles 100, respectively, via the input-output interface 203 and the communication device 205. The remote control section 210 may remotely control the plurality of vehicles 100 one by one in turn, or may remotely control the plurality of vehicles 100 in parallel at the same time. In the present embodiment, the control command transmitted from the remote control section 210 to each vehicle 100 includes a target value of the speed of the vehicle 100 and a target value of the yaw-axis angular velocity of the vehicle 100. Note that the remote control section 210 is referred to as a generation section in some cases.

The information acquisition section 220 acquires command information, which is information related to the control command transmitted from the remote control section 210 to each vehicle 100, internal sensor information, which is information related to a state of movement of each vehicle 100 acquired from the internal sensors 160, and external sensor information, which is information related to a state of movement of each vehicle 100 acquired from the external sensors 300.

The detection section 230 detects that a control command is transmitted from the communication device 205 to a vehicle 100 not corresponding to the control command, by comparing at least two of the command information, the internal sensor information, and the external sensor information acquired by the information acquisition section 220. Here, “a control command is transmitted from the communication device 205 to a vehicle 100 not corresponding to the control command” means that a control command generated to remotely control one vehicle 100 among the plurality of vehicles 100 is transmitted from the communication device 205 to a vehicle 100 other than the one vehicle 100. Such an event is referred to as a mix-up about the remote-control-target vehicle 100. When the remote control device 200 remotely controls the plurality of vehicles 100, there is a possibility that a mix-up about the remote-control-target vehicle 100 occurs due to a malfunction in the remote control system 10, a human error of a worker in the factory, or the like. The detection section 230 can detect a mix-up about the remote-control-target vehicle 100 by comparing at least two of the command information, the internal sensor information, and the external sensor information acquired by the information acquisition section 220. In the present embodiment, information related to a situation in which it is inappropriate to use the internal sensor information for comparison, and information related to a situation in which it is inappropriate to use the external sensor information for comparison are recorded in the database DB. When the current situation corresponds to the situation in which it is inappropriate to use the internal sensor information for comparison, the detection section 230 compares the command information and the external sensor information, without using the internal sensor information for comparison. When the current situation corresponds to the situation in which it is inappropriate to use the external sensor information for comparison, the detection section 230 compares the command information and the internal sensor information, without using the external sensor information for comparison.

For a method of detecting that a control command is transmitted from the communication device 205 to a vehicle 100 not corresponding to the control command, the detection section 230 can use one or more of various methods, for example, as follows.

### Detection Method D1

The detection section 230 uses at least two of the command information, the internal sensor information, and the external sensor information for comparison. The detection section 230 identifies a value of a parameter related to a vehicle 100 from each information used for comparison, and compares each identified value of the parameter. When the difference between the individual values of the parameter is a predetermined threshold value or more, the detection section 230 determines that a control command is transmitted from the communication device 205 to a vehicle 100 not corresponding to the control command. In other words, the detection section 230 detects that a control command is transmitted from the communication device 205 to a vehicle 100 not corresponding to the control command, by comparing at least two of the value of the parameter identified from the command information, the value of the parameter identified from the internal sensor information, and the value of the parameter identified from the external sensor information. The value of the parameter related to a vehicle 100 may be any type of numeric value as long as the numeric value reflects a state of the vehicle 100. For example, the value of the parameter related to a vehicle 100 may be the speed of a vehicle 100, may be the steering wheel angle of a vehicle 100, or may be the position coordinates of a vehicle 100.

### Detection Method D2

The detection section 230 uses at least two of the command information, the internal sensor information, and the external sensor information for comparison. The detection section 230 identifies identification information on a vehicle 100 from each information used for comparison, and compares each identified identification information. When the identification information does not coincide with each other, the detection section 230 determines that a control command is transmitted from the communication device 205 to a vehicle 100 not corresponding to the control command. In other words, the detection section 230 detects that a control command is transmitted from the communication device 205 to a vehicle 100 not corresponding to the control command, by comparing at least two of the identification information identified from the command information, the identification information identified from the internal sensor information, and the identification information identified from the external sensor information. The identification information included in each information used for comparison may be any type of information as long as the vehicle 100 can be identified by the information. For example, the identification information on a vehicle 100 may be a vehicle identification number (VIN), the chassis number of the vehicle 100, information related to the color or shape of the vehicle 100, or the identification number of a part mounted on the vehicle 100. For example, the identification information on a vehicle 100 is stored beforehand in the memory 112 of the vehicle 100; the processor 111 of the vehicle 100 generates internal sensor information including information acquired from the internal sensors 160 and the identification information stored in the memory 112; and the generated internal sensor information is transmitted to the remote control device 200 via the communication device 150. Here, when it can be determined whether or not each identification information to be compared is information related to the same vehicle 100, the type of each identification information to be compared may be different from the others. For example, when a vehicle identification number is included in one of the command information and the internal sensor information whereas a chassis number is included in the other, and the vehicle identification number and the chassis number are recorded in association with each other in the database DB, then the detection section 230, by referring to the database DB, can determine whether or not the identification information included in the command information and the identification information included in the internal sensor information are information related to the same vehicle 100.

The external sensors 300 include at least one external sensor. An external sensor is a sensor installed outside of the vehicles 100. An external sensor is used to detect a physical amount representing a state of movement of each vehicle 100. In the present embodiment, the external sensors 300 are configured by using a plurality of cameras installed in the factory. Each camera includes an undepicted communication device and can communicate with the remote control device 200 through wired communication or wireless communication.

The indication device 400 is a device for indicating to an administrator of the remote control system 10 or a worker in the factory that an abnormality occurs in the factory. Abnormalities include the fact that a control command is transmitted from the communication device 205 to a vehicle 100 not corresponding to the control command. In the description below, an administrator of the remote control system 10 or a worker in the factory is referred to as the administrator or the like. The indication device 400 is, for example, a warning buzzer installed in the factory or a warning lamp installed in the factory. The indication device 400 may be a tablet terminal carried by the administrator or the like. The indication device 400 includes an undepicted communication device and can communicate with the remote control device 200 through wired communication or wireless communication.

The process management device 500 is a device for managing the process of manufacturing the vehicles 100 in the factory. The process management device 500 is configured by using at least one computer. The process management device 500 includes an undepicted communication device and can communicate with the remote control device 200 and various equipment in the factory through wired communication or wireless communication. By communicating with the various equipment in the factory, the process management device 500 keeps track of when, where, and who will carry out what work on which vehicle 100, and when, where, and who carried out what work on which vehicle 100.

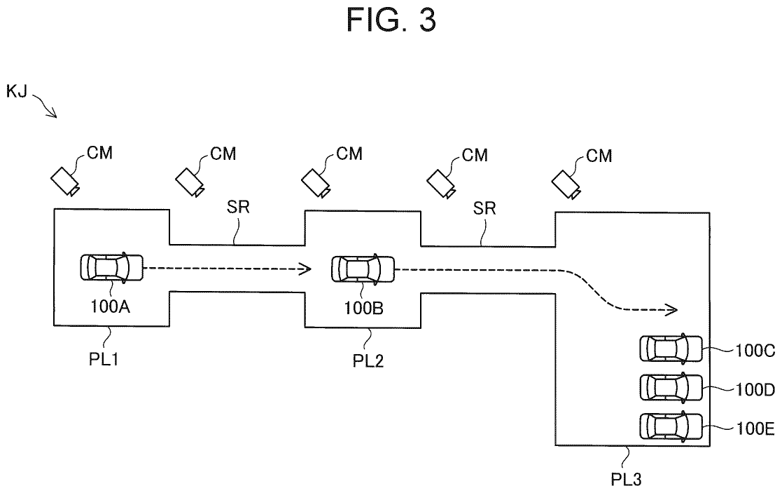

FIG. 3 is an explanatory diagram showing how vehicles 100 move by remote control in a factory KJ. Five vehicles 100A to 100E are depicted in FIG. 3. In the description below, simply, “vehicle 100” is used when a description is given without making a particular distinction among the five vehicles 100A to 100E. In the present embodiment, the factory KJ includes a first place PL1 for conducting assembly of a vehicle 100, a second place PL2 for conducting inspection of a vehicle 100, and a third place PL3 for storing a vehicle 100 that has passed the inspection. The first place PL1, the second place PL2, and the third place PL3 are connected through a drive lane SR on which a vehicle 100 can travel.

A vehicle 100 that has been assembled in the first place PL1 is equipped with the vehicle control device 110, the drive train 120, the steering system 130, the braking device 140, the communication device 150, and the internal sensors 160. The vehicle 100 that has been assembled in the first place PL1 travels from the first place PL1 to the second place PL2 by being remotely controlled by the remote control device 200. The vehicle 100 that has passed the inspection in the second place PL2 travels from the second place PL2 to the third place PL3 by being remotely controlled by the remote control device 200. Thereafter, the vehicle 100 is shipped from the factory KJ.

A method in which the remote control section 210 transfers a vehicle 100 by remote control is described. The remote control section 210 decides on a target route for a vehicle 100 to follow the drive lane SR and travel up to a destination. In the factory KJ, a plurality of cameras CM are installed that captures videos of the drive lane SR. The remote control section 210 can acquire, in real time, the relative position and orientation of the vehicle 100 with respect to the target route by analyzing the video captured by each camera CM. In the present embodiment, each camera CM is included in the external sensors 300. The remote control section 210 generates a control command to cause the vehicle 100 to travel along the target route, and transmits the control command to the vehicle 100. In the present embodiment, the control command indicates a target value of the speed of the vehicle 100 and a target value of the yaw-axis angular velocity of the vehicle 100. The vehicle control device 110 mounted in the vehicle 100 causes the vehicle 100 to travel by controlling the drive train 120, the steering system 130, and the braking device 140 according to the received control command. Accordingly, the vehicle 100 can be transferred without using transport equipment such as a crane or a conveyor.

In the present embodiment, the remote control section 210 causes the plurality of vehicles 100A to 100E to travel one by one by remote control. For example, the remote control section 210 transfers the vehicle 100B from the second place PL2 to the third place PL3 by remote control, thereafter changes the remote control target from the vehicle 100B to the vehicle 100A, and transfers the vehicle 100A from the first place PL1 to the second place PL2 by remote control. In the present embodiment, the remote control section 210 can also cause the plurality of vehicles 100A to 100E to travel in parallel at the same time by remote control. For example, the remote control section 210, while transferring the vehicle 100B from the second place PL2 to the third place PL3 by remote control, can also transfer the vehicle 100A from the first place PL1 to the second place PL2 by remote control.

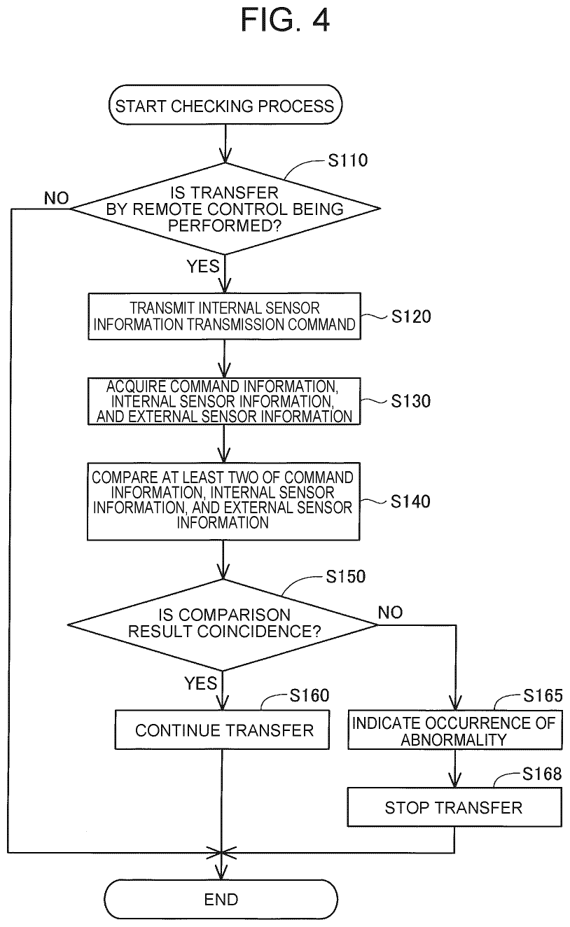

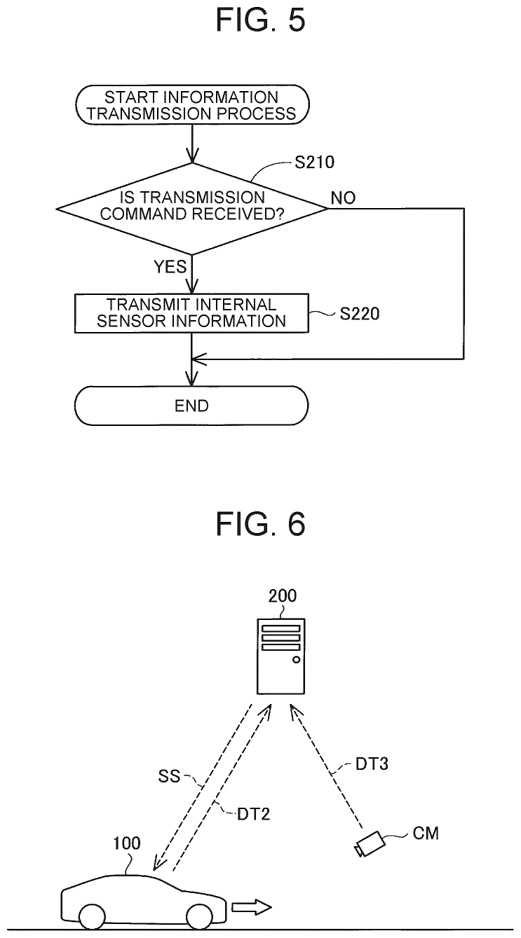

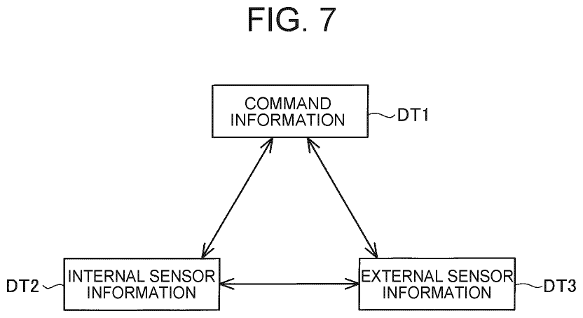

FIG. 4 is a flowchart showing details of a checking process executed by the remote control device 200. FIG. 5 is a flowchart showing details of an information transmission process executed by each vehicle 100. FIG. 6 is an explanatory diagram showing how the remote control device 200 performs transmission and reception of information. FIG. 7 is an explanatory diagram showing comparisons of command information DT1, internal sensor information DT2, and external sensor information DT3. A remote control method performed in the remote control system 10 is described by using FIGS. 4 to 7.

The checking process shown in FIG. 4 is repeatedly executed by the remote control device 200. When the checking process is started, in step S110, the information acquisition section 220 determines whether or not transfer of a vehicle 100 by remote control is being performed. In the description below, the vehicle 100 being remotely controlled is referred to as the target vehicle 100. When it is determined in step S110 that transfer of a vehicle 100 by remote control is not being performed, the information acquisition section 220 skips processes after step S110 and terminates the checking process.

When it is determined in step S110 that transfer of a vehicle 100 by remote control is being performed, in step S120, the information acquisition section 220 transmits, to the target vehicle 100, a control command to cause the target vehicle 100 to transmit internal sensor information DT2 to the remote control device 200. In the description below, the control command to perform the transmission of internal sensor information to the remote control device 200 is referred to as the transmission command SS.

In step S130, the information acquisition section 220 acquires command information DT1, the internal sensor information DT2, and external sensor information DT3. In the present embodiment, the information acquisition section 220 acquires the command information DT1 from the remote control section 210. As shown in FIG. 6, the information acquisition section 220 acquires the internal sensor information DT2 transmitted from the target vehicle 100 in response to the transmission command SS, and acquires the external sensor information DT3 transmitted from the external sensors 300.

In step S140, as shown in FIG. 7, the detection section 230 compares at least two of a state of movement of the target vehicle 100 derived from the command information DT1, a state of movement of the target vehicle 100 derived from the internal sensor information DT2, and a state of movement of the target vehicle 100 derived from the external sensor information DT3. Specifically, the detection section 230 compares at least two of a speed of the target vehicle 100 derived from the command information DT1, a speed of the target vehicle 100 derived from the internal sensor information DT2, and a speed of the target vehicle 100 derived from the external sensor information DT3. Note that the detection section 230 may compare, not speeds of the target vehicle 100, but, for example, yaw-axis angular velocities of the target vehicle 100, or may compare both speeds and yaw-axis angular velocities of the target vehicle 100.

In the present embodiment, the detection section 230, as a rule, compares the three of the speed of the target vehicle 100 derived from the command information DT1, the speed of the target vehicle 100 derived from the internal sensor information DT2, and the speed of the target vehicle 100 derived from the external sensor information DT3. However, the detection section 230 excludes the speed of the target vehicle 100 derived from the internal sensor information DT2 from comparison when the current situation matches a situation predetermined as a situation in which it is inappropriate to use the internal sensor information DT2 for comparison, and excludes the speed of the target vehicle 100 derived from the external sensor information DT3 from comparison when the current situation matches a situation predetermined as a situation in which it is inappropriate to use the external sensor information DT3 for comparison.

To the situation in which it is inappropriate to use the internal sensor information DT2 for comparison, for example, a situation corresponds in which the target vehicle 100 is caused to travel on a rough drive lane for inspection. In such a situation, it is difficult to appropriately measure the speed of the target vehicle 100 by using a vehicle speed sensor included in the internal sensors 160. In the present embodiment, the foregoing situation is recorded in the database DB as a situation in which it is inappropriate to use the internal sensor information DT2 for comparison. When information indicating that a process in manufacture of the target vehicle 100 is a process of conducting the inspection as described above is acquired from the process management device 500, the detection section 230 excludes the speed of the target vehicle 100 derived from the internal sensor information DT2 from comparison, and compares the remaining two, which are the speed of the target vehicle 100 derived from the command information DT1 and the speed of the target vehicle 100 derived from the external sensor information DT3.

To the situation in which it is inappropriate to use the external sensor information DT3 for comparison, for example, a situation corresponds in which the target vehicle 100 travels outdoors in the evening or the night. In such a situation, it is difficult to appropriately measure the speed of the target vehicle 100 by using the cameras CM included in the external sensors 300. In the present embodiment, the foregoing situation is recorded in the database DB as a situation in which it is inappropriate to use the external sensor information DT3 for comparison. When information indicating a process in which the target vehicle 100 moves outdoors and also information indicating that the current time falls in evening or night hours are acquired from the process management device 500, the detection section 230 excludes the speed of the target vehicle 100 derived from the external sensor information DT3 from comparison, and compares the remaining two, which are the speed of the target vehicle 100 derived from the command information DT1 and the speed of the target vehicle 100 derived from the internal sensor information DT2.

In step S150, the detection section 230 determines whether or not the compared states of movement coincide with each other. In the present embodiment, when the three of the speed of the target vehicle 100 derived from the command information DT1, the speed of the target vehicle 100 derived from the internal sensor information DT2, and the speed of the target vehicle 100 derived from the external sensor information DT3 are compared, the detection section 230 uses any one of the three speeds for a reference value and determines that the comparison result is coincidence when each of the differences of the remaining two speeds from the reference value is a predetermined value or less, and uses any one of the three speeds for a reference value and determines that the comparison result is not coincidence when at least one of the differences of the remaining two speeds from the reference value exceeds the predetermined value. When two of the speed of the target vehicle 100 derived from the command information DT1, the speed of the target vehicle 100 derived from the internal sensor information DT2, and the speed of the target vehicle 100 derived from the external sensor information DT3 are compared, it is determined that the comparison result is coincidence when the difference between the two speeds is a predetermined value or less, and it is determined that the comparison result is not coincidence when the difference between the two speeds exceeds the predetermined value.

When it is determined in step S150 that the comparison result is coincidence, in step S160, the remote control section 210 continues the transfer of the target vehicle 100 by remote control. Thereafter, the remote control device 200 terminates the checking process.

When it is determined in step S150 that the comparison result is not coincidence, in step S165, the remote control section 210 indicates to the administrator or the like, by using the indication device 400, that an abnormality occurs. In step S168, the remote control section 210 transmits a control command to brake the target vehicle 100 and thus stops the transfer of the target vehicle 100. Thereafter, the remote control device 200 terminates the checking process.

The information transmission process shown in FIG. 5 is repeatedly executed by each vehicle 100. When the information transmission process is started, in step S210, the vehicle control section 115 determines whether or not a transmission command SS is received from the remote control device 200. When it is not determined in step S210 that a transmission command SS is received from the remote control device 200, the vehicle control section 115 skips processes after step S210 and terminates the information transmission process. When it is determined in step S210 that a transmission command SS is received from the remote control device 200, in step S220, the vehicle control section 115 transmits internal sensor information DT2 to the remote control device 200, according to the transmission command SS. Thereafter, the vehicle control section 115 terminates the information transmission process.

According to the remote control system 10 in the present embodiment as described above, the detection section 230 can determine whether or not a vehicle 100 is appropriately remotely controlled, by comparing at least two of the state of movement of the vehicle 100 derived from the command information DT1, the state of movement of the vehicle 100 derived from the internal sensor information DT2, and the state of movement of the vehicle 100 derived from the external sensor information DT3. It can be checked that an intended vehicle 100 is being remotely controlled and that the vehicle 100 is operating in an intended state of movement, by comparing, in particular, the three states of movement, which are the state of movement of the vehicle 100 derived from the command information DT1, the state of movement of the vehicle 100 derived from the internal sensor information DT2, and the state of movement of the vehicle 100 derived from the external sensor information DT3.

Moreover, when the remote control device 200 remotely controls a plurality of vehicles 100 as in the present embodiment, a control command could be transmitted from the communication device 205 to a vehicle 100 not corresponding to the control command. For example, when the remote control device 200 remotely controls five vehicles 100A to 100E in the order of the vehicle 100E, the vehicle 100D, the vehicle 100C, the vehicle 100B, and the vehicle 100A as shown in FIG. 3, a control command could be transmitted from the communication device 205 to a vehicle 100 not corresponding to the control command. Specifically, after remote control of the vehicle 100C by the remote control device 200 is finished, if the communication device 150 removed from the vehicle 100C is erroneously mounted onto the vehicle 100A despite the arrangement that the communication device 150 removed from the vehicle 100C is mounted onto the vehicle 100B and remote control of the vehicle 100B by the remote control device 200 is started, a control command generated to remotely control the vehicle 100B is transmitted to the vehicle 100A. According to the present embodiment, even in such a case, the detection section 230 can detect that the control command transmitted from the communication device 205 is transmitted to the vehicle 100 not corresponding to the control command, by comparing at least two of command information, internal sensor information, and external sensor information acquired by the information acquisition section 220. Accordingly, it is possible to remove the communication device 150 erroneously mounted on the vehicle 100A from the vehicle 100A, mount the communication device 150 onto the vehicle 100B, and start remote control of the vehicle 100B.

In the present embodiment, when it is inappropriate to use the internal sensor information DT2, the detection section 230 excludes a state of movement of a vehicle 100 derived from the internal sensor information DT2 from comparison. Accordingly, it can be restrained from being erroneously determined that the vehicle 100 is not appropriately remotely controlled, despite the fact that the vehicle 100 is appropriately remotely controlled. By comparing two states of movement, which are a state of movement of the vehicle 100 derived from the command information DT1 and a state of movement of the vehicle 100 derived from the external sensor information DT3, it can be checked that the intended vehicle 100 is being remotely controlled, and that the vehicle 100 is operating in the intended state of movement.

In the present embodiment, when it is inappropriate to use the external sensor information DT3, the detection section 230 excludes a state of movement of a vehicle 100 derived from the external sensor information DT3 from comparison. Accordingly, it can be restrained from being erroneously determined that the vehicle 100 is not appropriately remotely controlled, despite the fact that the vehicle 100 is appropriately remotely controlled. By comparing two states of movement, which are a state of movement of the vehicle 100 derived from the command information DT1 and a state of movement of the vehicle 100 derived from the internal sensor information DT2, it can be checked that the vehicle 100 is operating in the intended state of movement.

In the present embodiment, the remote control device 200 continues transfer of a vehicle 100 when the comparison result is coincidence, and, when the comparison result is not coincidence, indicates to the administrator or the like, by using the indication device 400, that an abnormality occurs, and then stops the transfer of the vehicle 100 by remote control. Accordingly, the transfer of the unintended vehicle 100 can be restrained from being continued.

### B. Other Embodiments

(B1) In the remote control system 10 in the first embodiment described above, the information acquisition section 220 and the detection section 230 are provided in the remote control device 200. Instead, the information acquisition section 220 and the detection section 230 may be provided in the vehicle control device 110. When a result of comparison by the detection section 230 provided to the vehicle control device 110 is coincidence, the vehicle control section 115 continues the process of causing the vehicle 100 to travel according to a control command transmitted from the remote control device 200. When a result of the comparison is not coincidence, the vehicle control section 115 executes at least one process of a process of indicating occurrence of an abnormality, a process of changing the speed of the vehicle 100, and a processing of stopping receiving a control command transmitted from the remote control device 200. In the process of indicating occurrence of an abnormality, the vehicle control section 115 may indicate that an abnormality occurs by using the indication device 400 located outside of the vehicle 100, or may indicate to a worker located around the vehicle 100 that an abnormality occurs by honking a horn mounted in the vehicle 100. In the process of changing the speed of the vehicle 100, the vehicle control section 115 may stop the vehicle 100, or may decelerate the vehicle 100 within a range in which the vehicle 100 does not stop.

(B2) In the remote control system 10 in the first embodiment described above, the detection section 230 may compare the speed of the target vehicle 100 derived from the internal sensor information DT2 and the speed of the target vehicle 100 derived from the external sensor information DT3, with the speed of the target vehicle 100 derived from the command information DT1 excluded from comparison.

(B3) In the remote control system 10 in the first embodiment described above, the detection section 230 compares states of movement of the target vehicle 100. Instead, the detection section 230 may compare states of action other than the movement of the target vehicle 100. For example, the detection section 230 may compare states of swinging of a wiper of the target vehicle 100, states of turning-on of a headlamp of the target vehicle 100, or states of honking of a horn of the target vehicle 100. When the states of honking of the horn are compared, a microphone for detecting the sound of the horn is included in the external sensors 300.

(B4) In the remote control system 10 in the first embodiment described above, the detection section 230 may compare identification information on a vehicle 100 included in the command information and identification information on the vehicle 100 included in the internal sensor information. Here, for the identification information on a vehicle 100 included in the command information and in the internal sensor information, for example, the vehicle identification number of the vehicle 100, the chassis number of the vehicle 100, or the like can be used. Note that in such a case, the communication device 150 can be regarded as an internal sensor, and action of the communication device 150 to read the vehicle identification number or the like from the vehicle control section 115 can be regarded as action of detecting the identification information on the vehicle 100.

(B5) In the remote control system 10 in the first embodiment described above, the detection section 230 may compare identification information on a vehicle 100 read from an electronic tag attached to the vehicle 100 and identification information read from the vehicle control device 110. In such a case, first, the identification information stored in the electronic tag is read by a reading device. The reading device is connected to the remote control device 200 through wired communication or wireless communication, and the identification information read by the reading device is transmitted to the remote control device 200. Subsequently, a control command to remotely control the vehicle 100 having the identification information received from the reading device is generated by the remote control section 210, and the generated control command is transmitted to the vehicle 100. Subsequently, the identification information on the vehicle 100 stored in the vehicle control device 110 mounted in the vehicle 100 to which the control command is transmitted is read by the communication device 150 mounted in the vehicle 100, and the read identification information is transmitted to the remote control device 200. Then, the detection section 230 compares the identification information on the vehicle 100 read from the electronic tag and the identification information read from the vehicle control device 110. Note that in such a case, the reading device can be regarded as an external sensor, and the identification information read by the reading device can be regarded as external sensor information. Moreover, the identification information transmitted from the reading device to the remote control device 200 is used to generate the control command and therefore can be regarded as command information. In other words, the identification information stored in the electronic tag can be used for external sensor information and can be used also for command information.

(B6) In the remote control system 10 in the first embodiment described above, when the transfer of the target vehicle 100 is continued in step S160 of the checking process, the remote control section 210 may increase the speed limit of the target vehicle 100, compared to that before step S160.

(B7) In the remote control system 10 in the first embodiment described above, the remote control section 210 stops the transfer of the target vehicle 100 in step S168 of the checking process. Instead, in the checking process, the remote control section 210 may decelerate the target vehicle 100 within a range in which the transfer of the target vehicle 100 is not stopped. The remote control section 210 may decrease the speed limit of the target vehicle 100, compared to that before step S160, without decelerating the target vehicle 100.

(B8) In the remote control system 10 in the first embodiment described above, the remote control section 210 indicates occurrence of an abnormality by using the indication device 400 located outside of a vehicle 100. Instead, the remote control section 210 may indicate occurrence of an abnormality by honking the horn of the vehicle 100 by remote control, or may indicate occurrence of an abnormality by blinking the headlamp of the vehicle 100 by remote control.

(B9) In the remote control system 10 in the first embodiment described above, when it is determined that a state of movement derived from the command information DT1 and a state of movement derived from the external sensor information DT3 do not coincide, the detection section 230 may identify, by using the external sensors 300, a vehicle 100 of which a state of movement derived from external sensor information DT3 coincides with the state of movement derived from the command information DT1, in place of steps S165, S168, or in addition to steps S165, S168.

(B10) In the remote control system 10 in the first embodiment described above, each vehicle 100 is in a movable state by remote control at a time point when assembly work in the first place PL1 is finished. The movable state by remote control of a vehicle 100 refers to a state in which the vehicle 100 is equipped with the vehicle control device 110, the drive train 120, the steering system 130, the braking device 140, and the communication device 150 and can fulfill three functions of “traveling”, “turning”, and “stopping” by remote control. Accordingly, a vehicle 100 that is moving by remote control may be unequipped with at least one or some of interior parts such as a driver seat and a dashboard, may be unequipped with at least one or some of exterior parts such as a bumper and a fender, and may be unequipped with a bodyshell. The remaining parts, such as the bodyshell, may be attached to the vehicle 100 by a time when the vehicle 100 is shipped from the factory KJ, or the remaining parts, such as the bodyshell, may be attached to the vehicle 100 after the vehicle 100 is shipped from the factory KJ.

(B11) In the remote control system 10 in the first embodiment described above, the remote control section 210 automatically generates a control command to transmit to a vehicle 100. Instead, the remote control section 210 may generate a control command to transmit to a vehicle 100, according to an operation by an operator located outside of the vehicle 100. For example, the operator may operate a driving device that includes a display for displaying the position and orientation of a vehicle 100, as well as a steering wheel, an accelerator, and a brake pedal for operating the vehicle 100, and the remote control section 210 may generate a remote control command according to an operation applied to the driving device.

(B12) In the remote control system 10 in the first embodiment described above, the external sensors 300 may include light detection and ranging (LiDAR) in place of the cameras, or may include cameras and LiDAR.

(B13) The remote control system 10 in the first embodiment described above is used to remotely control vehicles 100 in the factory KJ where the vehicles 100 are manufactured. Instead, the remote control system 10 may be used to remotely control a vehicle 100 in places other than the factory KJ, such as a park, a commercial facility, and a university.

The present disclosure is not limited to the embodiments described above, and can be implemented in various configurations without departing from the gist thereof. For example, technical features in the embodiments that correspond to the technical features in the individual embodiments described in summary of the present disclosure can be replaced or combined as appropriate, in order to solve one or some, or all, of the problems described above, or to achieve one or some, or all, of the effects described above. A technical feature can be excluded as appropriate unless the technical feature is described as essential in the present description.

What is claimed is:

1. A control device configured to remotely control a plurality of mobile objects, comprising:
a generation section configured to generate a control command corresponding to each of the plurality of mobile objects;
a transmission section configured to transmit, to each of the plurality of mobile objects, the control command corresponding to the mobile object;
an information acquisition section configured to acquire command information, internal sensor information, and external sensor information, the command information being related to the control command, the internal sensor information being related to a state of movement of the mobile object detected by an internal sensor mounted in the mobile object, the external sensor information being related to a state of movement of the mobile object detected by an external sensor located outside of the mobile object; and
a detection section configured to detect that the control command is transmitted from the transmission section to one of the mobile objects not corresponding to the control command, by comparing at least two of the command information, the internal sensor information, and the external sensor information.

2. The control device according to claim 1, wherein the detection section is configured to detect that the control command is transmitted from the transmission section to one of the mobile objects not corresponding to the control command, by comparing at least two of a parameter value identified from the command information, a parameter value identified from the internal sensor information, and a parameter value identified from the external sensor information.

3. The control device according to claim 1, wherein the detection section is configured to detect that the control command is transmitted from the transmission section to one of the mobile objects not corresponding to the control command, by comparing at least two of identification information that identifies the mobile object and that is identified from the command information, identification information that identifies the mobile object and that is identified from the internal sensor information, and identification information that identifies the mobile object and that is identified from the external sensor information.

4. The control device according to claim 1, wherein the detection section is configured to compare the command information and the external sensor information when a current situation matches a situation predetermined as a situation in which it is inappropriate to use the internal sensor information for the comparison.

5. The control device according to claim 1, wherein the detection section is configured to compare the command information and the internal sensor information when a current situation matches a situation predetermined as a situation in which it is inappropriate to use the external sensor information for the comparison.

6. The control device according to claim 1, wherein the detection section is configured to compare three pieces of information that are the command information, the internal sensor information, and the external sensor information.

7. The control device according to claim 1, wherein the generation section is configured to
when the detection section detects that the control command is transmitted from the transmission section to one of the mobile objects not corresponding to the control command, stop the mobile object moving by transmitting a control command to brake the mobile object.

8. A remote control method for remotely controlling a plurality of mobile objects, comprising:
generating a control command corresponding to each of the plurality of mobile objects;
transmitting, to each of the plurality of mobile objects, the control command corresponding to the mobile object;
acquiring command information, internal sensor information, and external sensor information, the command information being related to the control command, the internal sensor information being related to a state of movement of the mobile object detected by an internal sensor mounted in the mobile object, the external sensor information being related to a state of movement of the mobile object detected by an external sensor located outside of the mobile object; and
detecting that the control command is transmitted to one of the mobile objects not corresponding to the control command, by comparing at least two of the command information, the internal sensor information, and the external sensor information.
